(19) United States
(12) Patent Application Publication
(10) Pub. No.: US 2007/0126993 A1
(43) Pub. Date: Jun. 7, 2007

(54) ILLUMINATION SYSTEM AND OPTICAL PROJECTION APPARATUS

(75) Inventors: Jiun-Shiun Wang, Hsinchu (TW); Sheng-Tang Lai, Hsinchu (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/551,092

(22) Filed: Oct. 19, 2006

(30) Foreign Application Priority Data
Dec. 6, 2005 (TW) 94142912

(51) Int. Cl. G03B 21/26

(52) U.S. Cl. 353/94

(57) ABSTRACT

An illumination system including a light source module and a light integration rod disposed nearby the light source module is provided. The light source module includes a rotary table and multiple point light sources. The rotary table has a rotating shaft and the rotating shaft is surrounded by the point light sources disposed on the rotary table. A part of the point light sources rotated in the front of the light integration rod in turn emit lights to form an illumination light beam. Moreover, an optical projection apparatus having the illumination system is provided.

### CROSS-REFERENCE TO RELATED APPLICATION

This application claims the priority benefit of Taiwan application serial No. 94142912, filed on Dec. 6, 2005. All disclosure of the Taiwan application is incorporated herein by reference.

### BACKGROUND OF THE INVENTION

1. Field of Invention

The present invention relates to an illumination system and optical projection apparatus and, more particularly, to an illumination system capable of providing an illumination light beam with high luminance and an optical projection apparatus having the illumination system.

2. Description of Related Art

Referring to FIG. 1A, a conventional optical projection apparatus 100 includes an illumination system 110, a projection lens 120, and a digital micro-mirror device (DMD) 130. The DMD 130 is disposed between the illumination system 110 and the projection lens 120. Moreover, the illumination system 110 includes a light source set 112, a light integration rod 114, and a lens 116. The light integration rod 114 is disposed between the light source set 112 and the DMD 130, while the lens 116 is disposed between the light integration rod 114 and the DMD 130. The light source set 112 is used for providing an illumination light beam 113 which is transmitted to the DMD 130 through the light integration rod 114 and the lens 116. The DMD 130 converts the illumination light beam 113 into an image beam 113′ and reflects the image beam 113′ to the projection lens 120. Then, the image beam 113′ transmitted to the projection lens 120 is projected to a screen (not shown) to form an image.

Referring to FIG. 1B, in the conventional technique, the light source set 112, fixed in the front of the light integration rod 114, comprises a red light-emitting diode (LED) R, a green LED G, and a blue LED B, and the number of the LEDs thereof is associated with a size of an opening of the light integration rod 114. The red, green, and blue LEDs R, G, B radiate red light, green light, and blue light sequentially. The DMD 130 is suitable for converting the red light, green light, and blue light into a red image beam, green image beam, and blue image beam respectively. The projection lens 120 is used for projecting the red image beam, green image beam, and blue image beam unto a screen (not shown) to form a true-color image overlapped by the red image, green image, and blue image on the screen.

The LED as a light-emitting source enables the image projected by the optical projection apparatus 100 to have high color saturation and vividness. As the conventional light source set 112 is fixed at the opening of the light integration rod 114, only a small number of LEDs can be disposed there and the light source set 112 emits red light, green light, and blue light sequentially. Thus, the LEDs disposed at the front of the light integration rod 114 do not emit light synchronically, such that the luminance of the illumination light beam 113 projected to the DMD 130 is low, and the luminance of the image projected by the optical projection apparatus 100 is low.

### SUMMARY OF THE INVENTION

An object of the present invention is to provide an illumination system for providing an illumination light beam with high luminance.

Another object of the present invention is to provide an optical projection apparatus, the illumination system therein provides an illumination light beam with high luminance, so the illumination light beam can project an image with high luminance.

To achieve above or other objects, the present invention provides an illumination system including a light source module and a light integration rod disposed nearby the light source module. The light source module includes a rotary table and multiple point light sources. The rotary table has a rotating shaft and the rotating shaft is surrounded by the point light sources disposed on the rotary table. A part of the point light sources rotated in front of the light integration rod in turn emit lights to form an illumination light beam incident into the light integration rod.

The present invention further provides an optical projection apparatus including a projection lens, a display device, and the above-described illumination system. The display device is disposed between the projection lens and the illumination system, and is located on the transmission path of the illumination light beam provided by the illumination system. The display device is suitable for converting the illumination light beam into an image beam and transmitting the image beam to the projection lens.

The display device is, for example, a digital micro-mirror device (DMD) or a reflective liquid crystal on silicon (LCOS) panel.

The point light sources are, for example, disposed in a ring strip region surrounding the rotating shaft.

The ring strip region is, for example, divided into multiple blocks, and the color of the point light sources in different blocks is different.

The color of the point light sources includes red, green, and blue.

The color of the point light sources further includes at least one of white, yellow, magenta, and cyan.

The point light sources are, for example, LEDs.

The illumination system further includes a lens, and the light integration rod is disposed between the light source module and the lens.

In the illumination system of the present invention, as a large number of point light sources radiate lights at the same time, an illumination light beam with high luminance can be provided, thereby increasing the luminance of the image projected by the optical projection apparatus. Moreover, as only the point light sources at the front of the light integration rod can radiate lights, the power consumption can be reduced.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

FIG. 1A is a schematic view of a conventional optical projection apparatus with a light-emitting diode as a light source.

FIG. 1B is a schematic view of a light source combination in FIG. 1A.

FIG. 2A is a structural view of an optical projection apparatus according to an embodiment of the present invention.

FIG. 2B is a structural view of a light source module as in FIG. 2A.

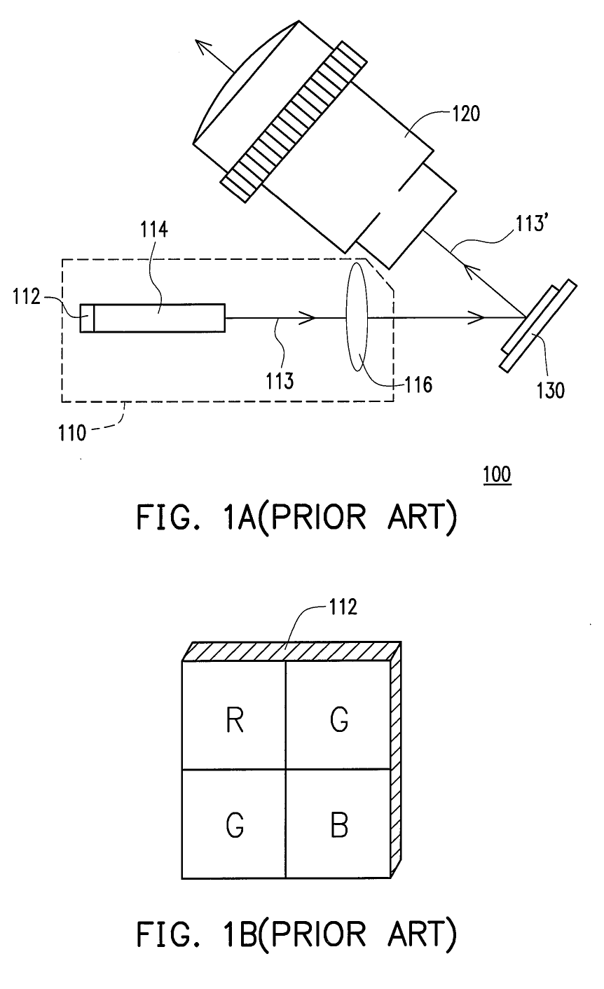

### DESCRIPTION OF THE EMBODIMENTS

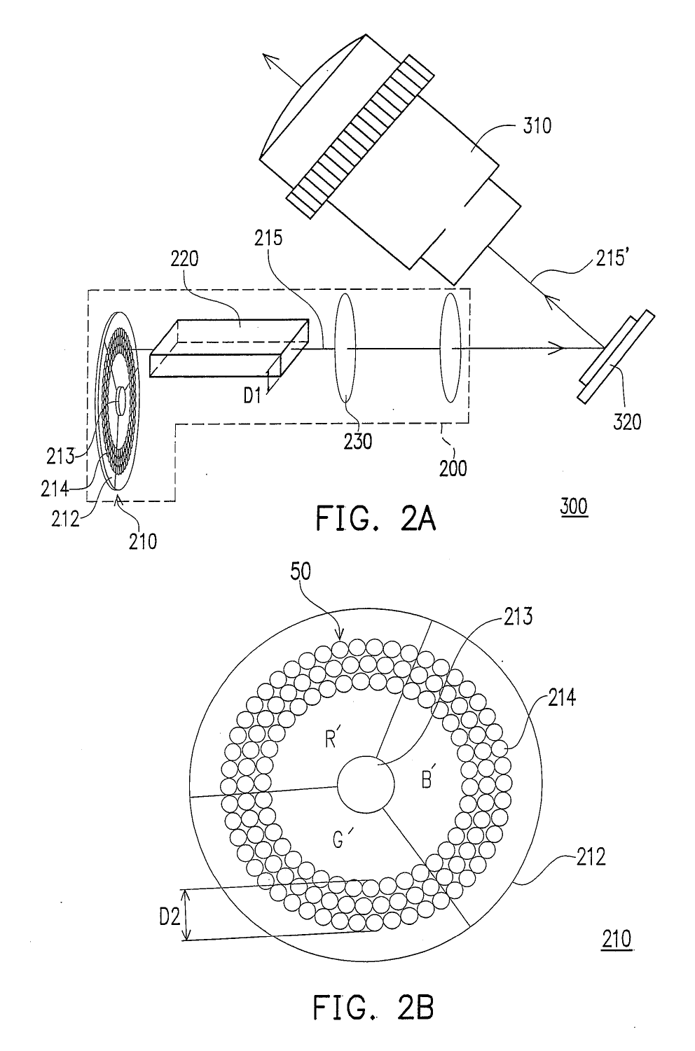

Referring to FIG. 2A, an optical projection apparatus 300 of the embodiment includes a projection lens 310, a display device 320, and an illumination system 200. The display device 320 is disposed between the projection lens 310 and the illumination system 200. The illumination system 200 includes a light source module 210 and a light integration rod 220 disposed nearby the light source module 210. The light source module 210 includes a rotary table 212 and multiple point light sources 214. The rotary table 212 has a rotating shaft 213 and the rotating shaft 213 is surrounded by the point light sources 214 disposed on the rotary table 212. A part of the point light sources 214 rotated in the front of the light integration rod 220 in turn emit lights to form an illumination light beam 215 being incident to the light integration rod 220. Moreover, the display device 320 is located on a transmission path of the illumination light beam 215. The display device 320 is suitable for converting the illumination light beam 215 into an image beam 215′ and transmitting the image beam 215′ to the projection lens 310.

In the optical projection apparatus 300, the illumination system 200 further includes at least one lens 230. The light integration rod 220 is disposed between the light source module 210 and the lens 230. Referring to FIG. 2B, the point light sources 214 are, for example, LEDs, and are, for example, disposed in a ring strip region 50 surrounding the rotating shaft 213. Furthermore, the ring strip region 50 can be divided into multiple blocks, blocks R′, G′, B′, and the point light sources 214 in different blocks have different colors. For example, the point light sources 214 in the block R′ are red LEDs, the point light sources 214 in the block G′ are green LEDs, and the point light sources 214 in block B′ are blue LEDs. When the rotary table 212 rotates, the point light sources 214 in the blocks R′, G′, B′ are rotated in the front of the light integration rod 220 in turn. As the point light sources 214 rotated in the front of the light integration rod 220 radiate lights, the illumination light beam 215 formed by the lights radiated by the point light sources 214 includes red illumination light beam, green illumination light beam and blue illumination light beam. The illumination light beam 215 is transmitted to the lens 230 through the light integration rod 220, and the lens 230 focuses the illumination light beam 215 on the display device 320.

As described above, the display device 320 is, for example, a digital micro-mirror device (DMD), a reflective liquid crystal on silicon (LCOS) panel, or other display panel, which is suitable for converting the illumination light beam 215 into an image beam 215′. In particular, the display device 320 is suitable for converting the red illumination light beam illumination, green illumination light beam, and blue illumination light beam in the light beam 215 into a red image beam, green image beam, and blue image beam in turn. That is, the image beam 215′ includes a red image beam, green image beam, and blue image beam. Moreover, the projection lens 310 projects the red image beam, green image beam, and blue image beam onto a screen (not shown) in turn to form a true-color image overlapped by the red image, green image, and blue image on the screen.

In the optical projection apparatus 300 of the embodiment, as the point light sources 214 at the front of the light integration rod 220 radiate lights at the same time, the luminance of the illumination light beam 215 of the present invention is higher, compared with the conventional light source set that only a part of the point light sources are illuminated. Therefore, the image luminance projected by the optical projection apparatus 300 can be increased. Moreover, only the point light sources 214 rotated in the front of the light integration rod 220 along with the rotary table 212 radiate lights, while the other point light sources 214 do not. Therefore, power consumption can be reduced. Furthermore, when the rotary table 212 rotates, a heat sinking function is also achieved in addition to driving the point light sources 214 to rotate, thereby reducing the internal temperature of the optical projection apparatus 300.

It should be noted that the profile of the rotary table 212 shown in FIGS. 2A and 2B is not limited to being circular. Moreover, the size of the light integration rod 220 is determined by the size of a light modulation device (e.g. the display device 320). The larger the size of the display device 320 is, the larger the size of the light integration rod 220 is, and the larger the thickness D1 of the light integration rod 220 is.

Also, as the bandwidth D2 of the ring strip region 50 is approximate to the thickness D1 of the light integration rod 220, a larger bandwidth D2 of the ring strip region 50 requires more point light sources 214. Therefore, the number of the point light sources 214 varies with the size of the display device 320. That is, the larger the size of the display device 320, the more the point light sources 214 are required.

Furthermore, the color of the point light sources 214 of the light source module 210 can farther include at least one of white (W), yellow (Y), magenta (M), and cyan (C) in addition to red (R), green (G), and blue (B). In particular, the color combination of the point light sources 214 of the light source module 210 can be RGBW, RGBWY, RGBWYMC, or other combinations in addition to the RGB. It should be noted that as the colors of the point light sources 214 are abundant, the color saturation and vividness of the image projected by the optical projection apparatus 300 can be enhanced.

In summary, the illumination system and optical projection apparatus of the present invention at least have the advantages as follows.

1. As a large number of point light sources radiate lights at the same time, the illumination system of the present invention can provide an illumination light beam with high luminance, thereby increasing the luminance of the image projected by the optical projection apparatus.

2. As only the point light sources rotated in the front of the light integration rod along with the rotary table radiate lights, power consumption is reduced.

3. When the rotary table rotates, a heat sinking function can also be achieved in addition to driving the point light sources to rotate, thereby reducing the internal temperature of the optical projection apparatus.

4. As the color of the point light sources of the light source module can also include other colors besides RGB, the color saturation and vividness of the image projected by the optical projection apparatus can be enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An illumination system, comprising:
a light source module, including:
a rotary table, having a rotating shaft;
multiple point light sources, surrounding the rotating shaft and disposed on the rotary table; and
a light integration rod, disposed nearby the light source module,
wherein a part of the point light sources rotated in the front of the light integration rod in turn emit lights to form an illumination light beam incident into the light integration rod.

2. The illumination system as claimed in claim 1, wherein the point light sources are disposed in a ring strip region surrounding the rotating shaft.

3. The illumination system as claimed in claim 2, wherein the ring strip region is divided into multiple blocks, and the point light sources in different blocks have different colors.

4. The illumination system as claimed in claim 1, wherein the point light sources comprise light-emitting diodes.

5. An optical projection apparatus, comprising:
an illumination system, including:
a light source module having:
a rotary table with a rotating shaft;
multiple point light sources, surrounding the rotating shaft and disposed on the rotary table;
a light integration rod, disposed nearby the light source module, wherein a part of the point light sources rotated in front of the light integration rod in turn emit lights to form an illumination light beam incident into the light integration rod;
a projection lens; and
a display device, disposed between the projection lens and the illumination system, and located on a transmission path of the illumination light beam, wherein the display device is suitable for converting the illumination light beam into an image beam and transmitting the image beam to the projection lens.

6. The optical projection apparatus as claimed in claim 5, wherein the point light sources are disposed in a ring strip region surrounding the rotating shaft.

7. The optical projection apparatus as claimed in claim 6, wherein the ring strip region is divided into multiple blocks, and the point light sources in different blocks have different colors.

8. The optical projection apparatus as claimed in claim 5, wherein the point light sources comprise light-emitting diodes.

9. The optical projection apparatus as claimed in claim 5, wherein the illumination system further comprises a lens, and the light integration rod is disposed between the light source module and the lens.
